(19) United States
(12) Patent Application Publication
(10) Pub. No.: US 2020/0344081 A1
(43) Pub. Date: Oct. 29, 2020

(54) CARRIER AGGREGATION SYSTEM, AND METHOD AND APPARATUS FOR TRANSMISSION BASED ON CACHED INFORMATION OF USER EQUIPMENT IN SAME

(71) Applicant: Korea Advanced Institute of Science and Technology, Daejeon (KR)

(72) Inventors: Wan CHOI, Daejeon (KR); Hyo Seung KANG, Daejeon (KR); Myung Gil KANG, Daejeon (KR)

(21) Appl. No.: 16/506,226

(22) Filed: Jul. 9, 2019

(30) Foreign Application Priority Data
Apr. 24, 2019 (KR) 10-2019-0047843

(51) Int. Cl. H04L 12/18; H04W 16/14; H04L 5/00; H04W 72/00

(52) U.S. Cl. CPC H04L 12/189; H04W 72/005; H04L 5/0098; H04W 16/14

(57) ABSTRACT

In a carrier aggregation system and a transmission method and apparatus based on cached information in the carrier aggregation system, the transmitter may be configured to configure multicast message sets corresponding to a plurality of carriers, respectively, based on at least one file to be received by each of receivers allocated to the carriers, respectively, and to allocate the multicast message sets to the carriers and transmitting the multicast message sets through the carriers.

### CROSS REFERENCE TO RELATED APPLICATION

This application is based on and claims priority under 35 U.S.C. 119 to Korean Patent Application No. 10-2019-0047843, filed on Apr. 24, 2019, in the Korean Intellectual Property Office, the disclosures of which is herein incorporated by reference in their entireties.

### BACKGROUND OF THE INVENTION

### 1. Technical Field

Various embodiments relate to a transmission method and apparatus based on user-cached information in a carrier aggregation system.

The invention was supported by Institute for Information & communications Technology Promotion(IITP) grant funded by the Korea government(MSIT) (No. 2018-0-00809, Development on the disruptive technologies for beyond 5G mobile communications employing new resources).

### 2. Description of the Related Art

As the needs for video streaming of high-picture quality suddenly increases, video traffic becomes a major cause of an explosive increase in radio network traffic. In general, a technology for solving suddenly increasing video traffic is unicast transmission in which user requests are separately processed, which may lead to a lot of transmission time. Recently, caching for previously storing data using the memory of a mobile edge node or end user shows results that such network traffic can be effectively processed, and lots of related researches are carried out. Two advantages may be obtained by storing some data in the memory of a user (user caching) at an off-peak time when user requests are small. First, there is an advantage in that data already stored in the user memory does not need to be transmitted. Second, there is an advantage in that several requests can be processed at once by transmitting a multicast message for several users using data stored in the user memory as additional information. Total network traffic can be reduced and system performance can be improved through a communication scheme using a user memory as a radio resource instead of radio communication resources, such as a frequency and an antenna.

Many researches regarding a caching gain using a user memory have been carried out in environments, such as a shared channel (wired channel) and a wireless channel. These researches have proposed a multicast transmission scheme capable of providing services to several users at the same time based on index coding using information stored in a user memory.

A carrier aggregation can improve transmission efficiency by receiving data from several carriers at the same time. However, a known carrier aggregation scheme is inefficient because it is based on unicast transmission in which one user is served in one carrier.

### SUMMARY OF THE INVENTION

If several users are served at the same time by allocating the users to one carrier using a user memory, transmission efficiency may be improved even in a carrier aggregation environment.

Accordingly, various embodiments provide a transmission method and apparatus based on a user memory in a carrier aggregation environment.

An operating method of a transmitter according to various embodiments may include configuring multicast message sets corresponding to a plurality of carriers, respectively, based on at least one file to be received by each of receivers allocated to the carriers, respectively, and allocating the multicast message sets to the carriers and transmitting the multicast message sets through the carriers.

A transmitter according to various embodiments may include a communication module and a processor connected to the communication module and configured to transmit at least one file to a plurality of receivers through a plurality of carriers using the communication module.

According to various embodiments, the processor may be configured to configure multicast message sets corresponding to a plurality of carriers, respectively, based on at least one file to be received by each of receivers allocated to the carriers, respectively, and to allocate the multicast message sets to the carriers and transmit the multicast message sets through the carriers.

A carrier aggregation system according to various embodiments may include a plurality of receivers and a transmitter configured to transmit at least one file to the receivers through a plurality of carriers.

According to various embodiments, a transmitter may be configured to configure multicast message sets corresponding to a plurality of carriers, respectively, based on at least one file to be received by each of receivers allocated to the carriers, respectively, and to allocate the multicast message sets to the carriers and transmit the multicast message sets through the carriers.

### BRIEF DESCRIPTION OF THE DRAWINGS

FIG. 1 is a diagram showing a carrier aggregation system according to various embodiments.

FIG. 2 is a diagram showing an example in which the files of a transmitter and receivers in FIG. 1 are stored.

FIG. 3 is a diagram showing an operating method of a carrier aggregation system according to various embodiments.

FIG. 4 is a diagram showing a transmitter according to various embodiments.

FIG. 5 is a diagram showing an operating method of the transmitter according to various embodiments.

FIG. 6 is a diagram showing an operation of configuring a multicast message in FIG. 5.

FIGS. 7a, 7b, 8, 9 and 10 are diagrams illustrating an operation of configuring a multicast message in FIG. 5.

FIG. 11 is a diagram showing an operation of configuring a carrier message in FIG. 5.

FIGS. 12 and 13 are diagrams illustrating an operation of configuring a carrier message in FIG. 5.

FIG. 14 is a diagram for illustrating performance of the transmitter according to various embodiments.

### DETAILED DESCRIPTION

Hereinafter, various embodiments of this document are described with reference to the accompanying drawings.

According to various embodiments, there are provided a transmission method and apparatus using a user memory in a carrier aggregation environment. Unlike in a known transmission technology using a user memory proposed in wired and wireless communication environments, a generated multicast message needs to be different depending on the configuration of users allocated to carriers (user allocation to carrier), a multicast message having a different order needs to be generated based on a user configuration or a difference between carrier transmission rates, and multicast/unicast mixed transmission is necessary. In order to improve transmission efficiency, a multicast message needs to be generated for as many users as possible by incorporating a user configuration allocated to a carrier, and the message needs to be well distributed by incorporating the transmission rate of the carrier. According to various embodiments, there are provided a multi-order multicast transmission method and apparatus based on user memory-stored information (additional information), which reduce a total transmission time (T) necessary to satisfy a user request by incorporating given user allocation and a transmission rate.

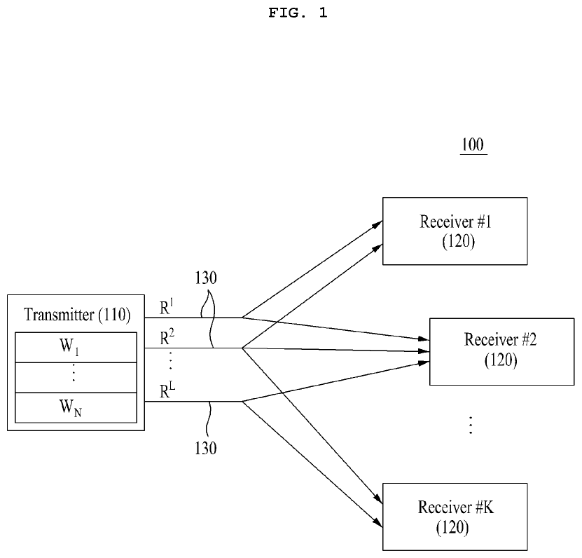

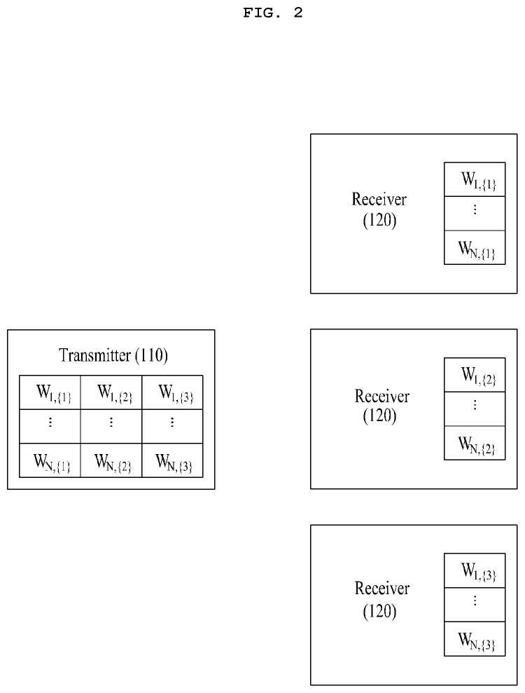

FIG. 1 is a diagram showing a carrier aggregation system 100 according to various embodiments. FIG. 2 is a diagram showing an example in which the files of a transmitter 110 and receivers 120 in FIG. 1 are stored.

Referring to FIG. 1, the carrier aggregation system 100 according to various embodiments may include the transmitter 110 and a plurality of, that is, K, receivers 120. For example, the transmitter 110 may be a base station, and the receivers 120 may be user equipments. The transmitter 100 and the receivers 120 may be connected through a plurality of, that is, L, carriers 130. In this case, at least one receiver 120 may be allocated to each carrier 130. That is, a plurality of (≤K) receivers 120 may be allocated to at least one of the carriers 130. In this case, a user set indicative of the receivers 120 allocated to the carrier 130 may be defined as V^{l} (l∈{1, . . . , L}), and the transmission rate of l-th carrier may be defined as R^{l} (l∈{1, . . . , L}).

The transmitter 110 may have stored a plurality of, that is, N (≥K), files. In this case, each file may be defined as Wᵢ (i∈{1, . . . , N}), and a file size may be F bits. Each receiver 120 may store at least one of files (Wᵢ). Each receiver 120 may include a memory. In this case, the memory of the receiver 120 may store a plurality of, that is, M (≤N), files (Wᵢ), and a memory size may be MF bits. In this case, the transmitter 110 stores information on the memory of each receiver 120. The memory information may indicate information on at least one file (Wᵢ) stored in the receiver 120. In this case, the memory information of the receiver 120 may be defined as Zₖ (k∈{1, . . . , K}). To this end, each receiver 120 may request at least one of the files (Wᵢ) from the transmitter 110. In this case, a file requested by the receiver 120 may be defined as Wₖ (k∈{1, . . . , K}).

The transmitter 100 may encode and transmit a file, requested by each receiver 120, based on channel information of the receiver 120 and memory information of the receiver 120. In a time index t, the received signal (Y_{k,t}) of each receiver 120 may be a set of transmission signals of a carrier 130 to which the receiver 120 has been allocated, as represented in Equation 1. Each receiver 120 may decode a required file (Wₖ) using received signals (Y_{k,1}, . . . Y_{k,T}) during a time T (t∈{1, . . . , T}) and memory information (Zₖ).

Y_{k, t}={xₜ^{l}:k∈V^{l}, l∈{1, . . . , L}} [Equation 1]

According to an embodiment, all the receivers 120 may store at least one of the files (Wᵢ, i∈{1, . . . , N}) of the transmitter 110 using a uniform caching method. In the transmitter 110, all the files (Wᵢ) may be divided into a plurality of subfiles (W_{i,r}), as represented in Equation 2. All the subfiles (W_{i,r}) may have the same size. In this case,

in each file (Wᵢ), the number of subfiles (W_{i,r}) is

$$( \begin{matrix}K \\ γ\end{matrix} ) ,$$

and the size of the subfiles (W_{i,r}) may be represented like Equation 3. Accordingly, the receiver 120 may store all the subfiles (W_{i,r}) of each file (Wᵢ). In this case, the memory information (Zₖ) of each receiver 120 may be represented like Equation 4.

$$\begin{matrix} {W}_{i} = ( {W}_{i , T} \text{:} T ⋐ \{ 1 , … , K \} , \vert T \vert = γ ) , γ = M K / N & [ Equation 2 ] \\ \vert {W}_{i , T} \vert = F / ( \begin{matrix}K \\ γ\end{matrix} ) & [ Equation 3 ] \\ {Z}_{k}^{U C} = ( {W}_{i , T} \text{:} k ∈ T ⋐ \{ 1 , … , K \} , \vert T \vert = γ , i ∈ \{ 1 , … , N \} ) & [ Equation 4 ]\end{matrix}$$

For example, in the environment (γ=MK/N=1) in which three receivers 120 are present and the memory size of the receiver 120 is M=N/3, the transmitter 110 may store N files (Wᵢ), as shown in FIG. 2. In this case, each file may be divided into three subfiles Each of the receivers 120 may store the subfiles (W_{i,r}) of any one of the files (Wᵢ), as shown in FIG. 2.

According to another embodiment, all the receivers 120 may store at least one of the files (Wᵢ, i∈{1, . . . , N}) of the transmitter 110 using a random caching method. In the transmitter 110, all the files (Wᵢ) may be divided into a plurality of subfiles (W_{i,r}), as represented in Equation 5. All the subfiles (W_{i,r}) may have the same size. Accordingly, the receiver 120 may store subfiles (W_{i,r}), corresponding to MF/N bits, with respect to each file (Wᵢ). In this case, memory information (Zₖ) of each receiver 120 may be represented like Equation 6. In this case, in each file (Wᵢ), the size of the subfiles (W_{i,r}) may be represented like Equation 7.

$$\begin{matrix} {W}_{i} = ( {W}_{i , T} \text{:} τ ⋐ \{ 1 , … , K \} , \vert τ \vert ∈ \{ 0 , … , K \} ) & [ Equation 5 ] \\ {Z}_{k}^{R C} = ( {W}_{i , T} \text{:} k ∈ τ ⋐ \{ 1 , … , K \} , \vert τ \vert ∈ \{ 0 , … , K \} , i ∈ \{ 1 , … , N \} ) & [ Equation 6 ] \\ \vert {W}_{i , T} \vert = \frac{{M}^{\vert τ \vert}}{N} \cdot {( 1 - \frac{M}{N} )}^{K - \vert τ \vert} \cdot F & [ Equation 7 ]\end{matrix}$$

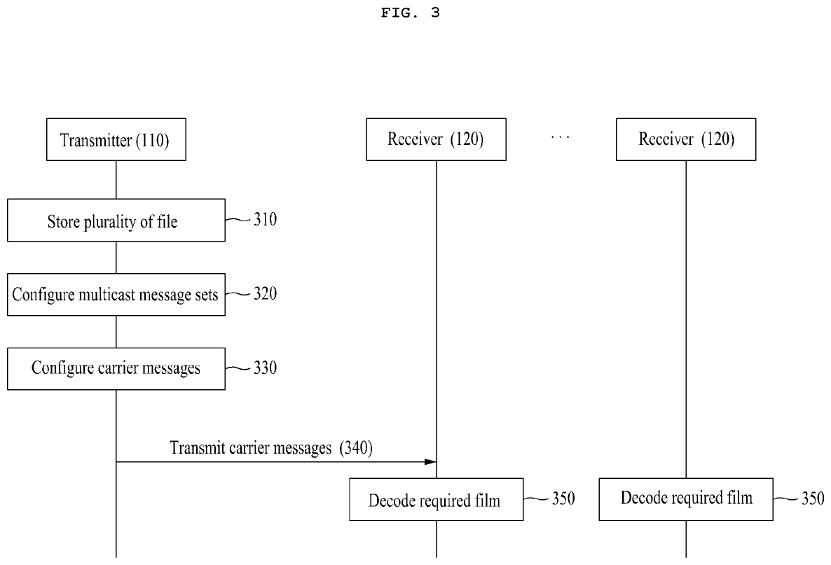

FIG. 3 is a diagram showing an operating method of the carrier aggregation system 100 according to various embodiments.

Referring to FIG. 3, at operation 310, the transmitter 110 may have stored a plurality of, that is, N (≥K), files (Wᵢ, i∈{1, . . . , N}). In this case, the size of the files (Wᵢ) may be F bits. In this case, all the files (Wᵢ) may be divided into a plurality of subfiles (W_{i,r}). Furthermore, the transmitter 110 stores memory information (Zₖ) of each receiver 120. The memory information may indicate information on at least one file stored in the receiver 120.

At operation 320, the transmitter 110 may configure multicast message sets (W^{L}, L^{⊂{}1, . . . , L}). The transmitter 110 may configure the multicast message sets (W^{L}), respectively corresponding to carriers 130, based on at least one file to be received by each of the receivers 120 allocated to the carrier 130. Each multicast message set (W^{L}) may include multicast messages to be transmitted in each carrier 130. In this case, the transmitter 110 may configure multicast messages to be transmitted in each carrier 130 based on the memory information (Zₖ) of each receiver 120, the configurations of the receivers 120 allocated to the carrier 130, and the transmission rate (R¹) of each carrier 130.

At operation 330, the transmitter 110 may configure carrier messages (X^{l}, l∈{1, . . . , L}). The transmitter 110 may configure the carrier messages (X^{l}) for the respective carriers 130 by allocating the multicast message sets (W^{L}) to the carriers 130. In this case, the transmitter 110 may configure the carrier messages (X^{l}) by allocating the multicast messages of the multicast message set (W^{L}) to the carriers 130 based on the message size (|W^{L}|) of the multicast message set (W^{L}) and the transmission rate (R^{l}) of each carrier 130.

At operation 340, the transmitter 110 may transmit the carrier messages (X^{l}) through the carriers 130. The transmitter 110 may transmit the carrier messages (X^{l}) based on the transmission rate (R^{l}) of each carrier 130.

Accordingly, at operation 350, each of the receivers 120 may decode at least one required file (Wₖ) from at least one carrier message (X^{l}) received through at least one of the carriers 130. The receiver 120 may decode the required file (Wₖ) from at least one carrier message (X^{l}) based on the memory information (Zₖ) of the receiver 120. According to an embodiment, all the receivers 120 may store at least one of the file (Wᵢ, i∈{1, . . . , N}) of the transmitter 110 using a uniform caching method. According to another embodiment, all the receivers 120 may store at least one of the file (Wᵢ, i∈{1, . . . , N}) of the transmitter 110 using a random caching method.

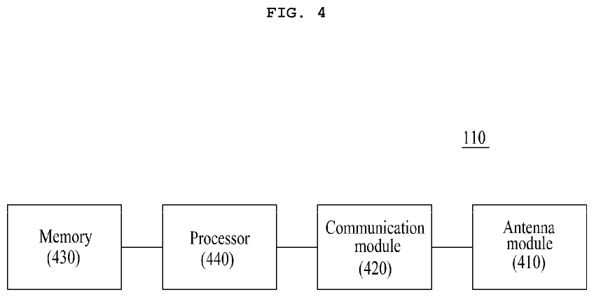

FIG. 4 is a diagram showing the transmitter 110 according to various embodiments.

Referring to FIG. 4, the transmitter 110 according to various embodiments may include at least one of an antenna module 410, a communication module 420, a memory 430 or a processor 440.

The antenna module 410 is a multi-antenna module and may include at least one, that is, Nₜ antennas. The antenna module 410 may transmit a signal to the outside or receive a signal from the outside.

The communication module 420 may support the execution of communication of the transmitter 110. The communication module 420 may establish a communication channel for the transmitter 110, and may perform communication through the communication channel. In this case, the communication module 420 may establish the communication channel between the transmitter 110 and the receivers 120.

The memory 430 may store various data used by at least one element of the transmitter 110. The data may include input data or output data for a program or a command related to the program. For example, the memory 430 may include at least one of a volatile memory or a non-volatile memory. The memory 430 may have stored a plurality of, that is, N (≥K), files (Wᵢ, i∈{1, . . . , N}). In this case, the size of the files (Wᵢ) may be F bits. In this case, all the files (Wᵢ) may be divided into a plurality of subfiles (W_{i,r}). Furthermore, the memory 430 stores memory information (Zₖ) of each receiver 120. The memory information may indicate information on at least one file stored in each receiver 120.

The processor 440 may control the elements of the carrier aggregation system 100 by executing a program of the memory 330, and may perform data processing or operation. The processor 440 may transmit at least one file (Wᵢ) to a plurality of receivers 120 through a plurality of carriers 130 using the communication module 420. To this end, the processor 440 may configure multicast message sets (W^{L}, L^{⊂}{1, . . . , L}). The processor 440 may configure the multicast message sets (W^{L}), respectively corresponding to the carriers 130, based on at least one file to be received by each of the receivers 120 allocated to the carrier 130. Furthermore, the processor 440 may configure carrier messages (X^{l}, l∈{1, . . . , L}) using the multicast message sets (W^{L}). The processor 440 may configure the carrier messages (X^{l}) for the respective carriers 130 by allocating the multicast message sets (W^{L}) to the carriers 130. The processor 440 may transmit the carrier messages (X^{l}) through the carriers 130. Accordingly, the receivers 120 may decode at least one required file (Wₖ) through the carrier messages (X^{l}).

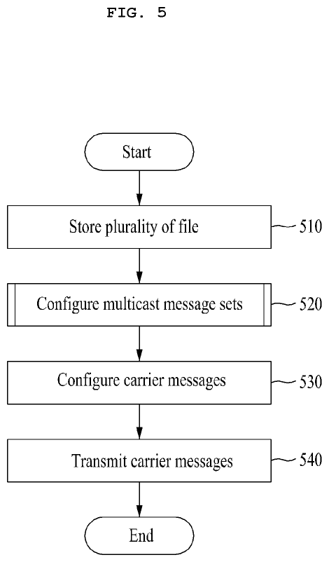

FIG. 5 is a diagram showing an operating method of the transmitter 110 according to various embodiments.

Referring to FIG. 5, at operation 510, the transmitter 110 may have stored a plurality of files. The memory 430 may have stored a plurality of, that is, N (≥K), files (Wᵢ, i∈{1, . . . , N}). In this case, the size of the files (Wᵢ) may be F bits. In this case, all the files (Wᵢ, i∈{1, . . . , N}) may be divided into a plurality of subfiles (W_{i,r}). Furthermore, the memory 430 stores memory information (Zₖ) of each receiver 120. The memory information may indicate information on at least one file stored in each receiver 120.

At operation 520, the transmitter 110 may configure multicast message sets (W^{L}, L^{⊂}{1, . . . , L}). The processor 440 may configure the multicast message sets (W^{L}), respectively corresponding to carriers 130, based on at least one file to be received by each of the receivers 120 allocated to the carriers 130. Each of the multicast message sets (W^{L}) may include multicast messages to be transmitted in each carrier 130. In this case, the processor 440 may configure multicast messages to be transmitted in each carrier 130 based on memory information (Zₖ) of each receiver 120, the configurations of the receivers 120 allocated to the carriers 130, and the transmission rate (R^{l}) of each carrier 130.

The multicast message sets (W^{L}, L^{⊂}{1, . . . , L}) may include multicast messages having an order-i ∈{1, . . . , γ+1} based on a user set (V^{l}) indicative of the receivers 120 allocated to each carrier (l∈{1, . . . , L}), the transmission rate (R^{l}) of each carrier (l∈{1, . . . , L}), and memory information of each receiver 120. In this case, the order-i multicast message is a multicast message for i receivers 120 using XOR operation (⊕). The multicast message may be generated using memory information already owned by each receiver 120 through a received multicast message so that a required subfile can be decoded. In uniform caching, a multicast message having an order of γ+1=MK/N+1 may be generated because each subfile is stored in the memories of γ receivers 120, but a message of a lower order needs to be generated based on the configurations of the receivers 120 allocated to the carrier (l∈{1, . . . , L}). The processor 440 needs to generate a multicast message of a higher order as high as possible and generate not-overlapping multicast messages. In this case, a transmission time can be reduced because the number of all multicast messages is reduced.

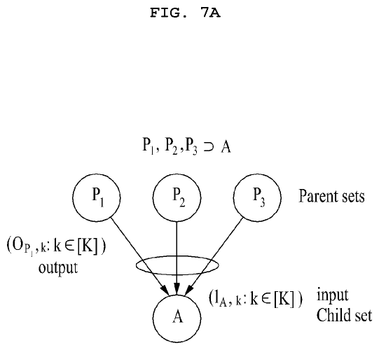

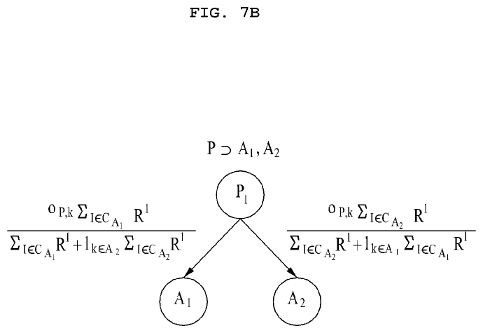

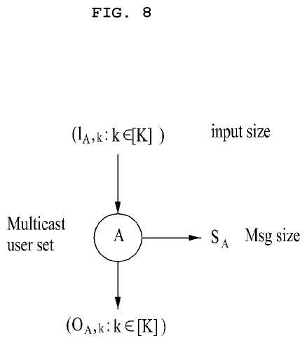

According to various embodiments, the processor 440 may search for multicast user sets from a higher order to a lower order (e.g., from a user set having a greater size to a user set having a smaller size) by incorporating a user set (V^{l}, l∈{1, . . . , L}) indicative of the receivers 120 allocated to the carrier (l∈{1, . . . , L}), and may generate a corresponding multicast message. That is, the processor may search for a multicast user set which may be transmitted in each carrier (l∈{1, . . . , L}) from a high order. In this case, as shown in FIGS. 7a and 7b, a parent-child concept may be introduced into the multicast user set. User sets of a higher order, including A with respect to a multicast user set A (child set), may be considered to be a parent set. In this case, several parent sets may be present as shown in FIG. 7a, and several child sets may be present in one parent as shown in FIG. 7b. As shown in FIG. 8, the processor 440 may generate a multicast message in each parent set, may divide the remaining messages into several child sets in proportion to the transmission rate of a related carrier (l∈{1, . . . , L}), may transmit the messages, and may generate a new multicast message having the smallest size S_{A} using XOR operation by combining messages, received from several parent sets, with each child set.

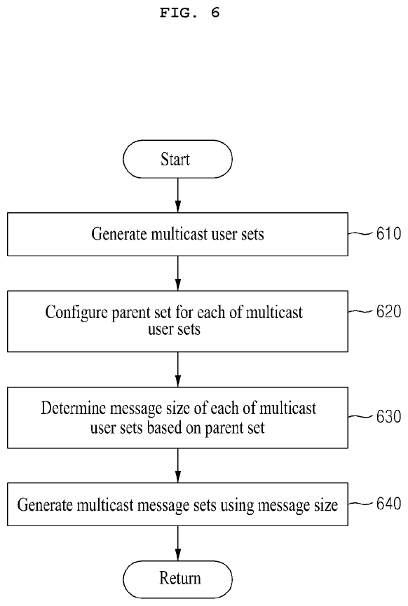

According to an embodiment, each of all the receivers 120 may be configured to store at least one of the files (Wᵢ, i∈{1, . . . , N}) of the transmitter 110 using a uniform caching method. In such a case, the transmitter 110 may configure a multicast message by repeating an algorithm, such as that described below with reference to FIG. 6, with respect to i∈{1, . . . , γ+1}.

FIG. 6 is a diagram showing an operation of configuring a multicast message in FIG. 5. FIGS. 7a, 7b, 8, and 10 are diagrams illustrating an operation of configuring a multicast message in FIG. 5.

Referring to FIG. 6, at operation 610, the transmitter 110 may generate multicast user sets. The processor 440 may generate the multicast user sets which can be transmitted and have a size of γ−i+² based on a user set (V^{l}, l∈{1, . . . , L}) indicative of receivers 120 allocated to each carrier (l). Accordingly, the processor 440 may generate a set ([A]ᵢ, i∈{1, . . . , γ+1}) of multicast user sets. When (initialization, order-(γ+1), i=1, [A]₁ may be defined as an order-(γ+1) multicast user set ([A]₁ ←{A: A^{⊂}{1, . . . , K}, |A|=γ+1}) related to all the messages that need to be transmitted to each user based on memory information. When i≠1 (order-(γ−i+2), [A]ᵢ may generated as a multicast user set which may be transmitted in each carrier (l), ([A]ᵢ ←{A: A^{⊂}V^{l}, l∈{1, . . . , L}, |A|=γ−i+2}), by taking into consideration a user set allocated to the carrier.

At operation 620, the transmitter 110 may configure at least one parent set for each of the multicast user sets. The processor 440 may search for a parent set (P_{A}), having a higher order including A, with respect to each multicast user set A∈[A]ᵢ as represented in Equation 8.

P_{A}=∪_{A}_{^{⊂}}_{A′∈[A]}_{ᵢ} {P: P∈ arg min_{A}_{^{⊂}}_{P′}_{^{⊂A′, P′∈[A]}}_{ₘ}_{, l≤m≤i-1}|P′∩A′| [Equation 8]

At operation 630, the transmitter 110 may determine the message size of each of the multicast user sets based on the parent set. The processor 440 may divide the remaining messages of the parent set in proportion to the transmission rate (R¹) of a carrier in which child sets may be transmitted so that the messages do not overlap, and may distribute the messages to the child sets. Accordingly, the message (W_{k,A\{k}}, k∈A) of a multicast user set (A∈[A]ᵢ) may be generated as represented in Equation 9.

$${W}_{k , A \backslash \{ k \}} ← Concatenation of parts of {W}_{k , P \backslash \{ k \}} for all P ∈ {P}_{A} with each size of {O}_{P , k} \cdot \frac{{\sum }_{1 ∈ {L}_{A}} {R}^{1}}{{ \sum }_{k ∈ {A}^{′} ∈ {[ A ]}_{i}} {1}_{{A}^{′} ⋐ P} \cdot {\sum }_{{1}^{′} ∈ {L}_{{A}^{′}}} {R}^{{1}^{′}}} , \\ {1}_{x} = \{ \begin{matrix}1 & if x is true \\ 0 & otherwise\end{matrix} . \qquad [ Equation 9 ]$$

In Equation 9, W_{k,A\{k}} may indicate a message for the receiver 120(k). I_{A,k} may indicate a message size for the receiver 120(k) and may be represented like Equation 10.

$${I}_{A , k} = \{ \begin{matrix}0 & if k ∉ A \\ 1 & if 1 = 1 , k ∈ A \\ { \sum }_{P ∈ {P}_{A}} \frac{{O}_{P , k} {\sum }_{1 ∈ {L}_{A}} {R}^{1}}{\begin{matrix}{ \sum }_{k ∈ {A}^{′} ∈ {[ A ]}_{i}} {1}_{{A}^{′} ⋐ P} \cdot \\ {\sum }_{{1}^{′} ∈ {L}_{{A}^{′}}} {R}^{{1}^{′}}\end{matrix}} & if 1 \geq 2 , k ∈ A ∈ [ {A}_{i} ]\end{matrix} , \\ {L}_{A} = \{ 1 \text{:} 1 ∈ \{ 1 , … , L \} , A ⋐ {V}^{1} \} \qquad [ Equation 10 ]$$

In this case, O_{P,k} may indicate the size of the remaining messages for the receiver 120(k) of the parent set (P). L_{A} may indicate a set of carriers (l) in which the multicast message related to the multicast user set (A) may be transmitted.

At operation 640, the transmitter 110 may generate the multicast message sets using the message size. The processor 440 may generate a multicast message (⊕_{k∈A} \tilde{W}_{k,A\{k}}) for the multicast user set (A) in a message size (S_{A}=min_{k∈A} I_{A,k}), and may update the remaining messages (W_{k,A\{k}}=W_{k,A\{k}}\\tilde{W}_{k,A\{k}}). In this case, \tilde{W}_{k,A\{k}} may indicate one portion of W_{k,A\{k}}, that is, the message size (S_{A}). O_{A,k} may indicate the size of the remaining messages for the receiver 120(k) of the multicast user set (A), and may be represented like Equation 11. Furthermore, the processor 440 may put the generated message (⊕_{k∈A} \tilde{W}_{k,A\{k}}) into the message set (W^{L}^{_{A}}). Thereafter, the processor may return to FIG. 5.

$${O}_{A , k} = \{ \begin{matrix}0 & if k ∉ A \\ {I}_{A , k} - {S}_{A} & if k ∈ A\end{matrix} \qquad [ Equation 11 ]$$

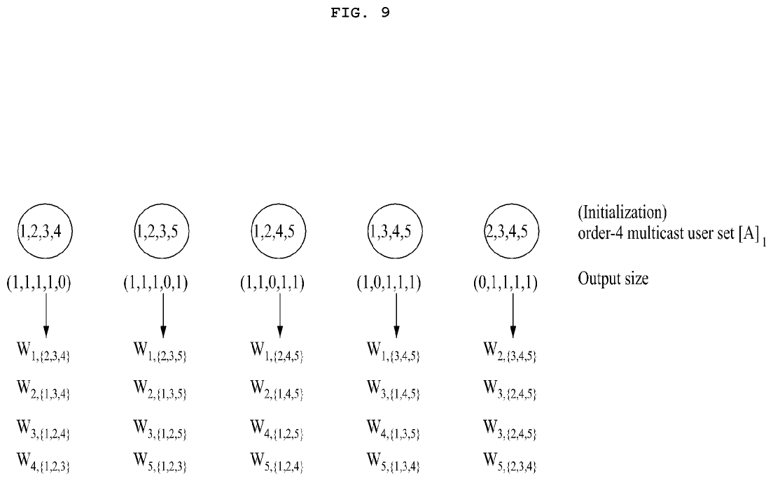

For example, in the environment where L=4, K=5, γ=MK/N=3, and R=(10,10,10,10), when the configurations of the receivers 120 allocated to each carrier are V¹={1, 2, 4}, V²={1, 3, 5}, V³={2, 4, 5}, V⁴={3, 4, 5}, the multicast message set (W^{L}, L^{⊂}{1, 2, 3, 4}) may be configured as follows. In this case, the receivers 120 (e.g., a user 1, a user 2, a user 3, and a user 4) need to receive four subfiles as shown in FIG. 9. For example, the user 1 needs to receive a subfile of W_{1,{2,3,4}}, W_{1,{2,3,5}}, W_{1,{2,4,5}}, W_{1,{3,4,5}}. In general, if the configurations of the receivers 120 allocated to the carrier are neglected, the transmitter 110 has only to group subfiles required by the four receivers 120 as in W_{1,{2,3,4}} ⊕ W_{2,{1,3,4}} ⊕ W_{3,{1,2,4}} ⊕ W_{4,{1,2,3}} based on memory information, and to transmit an order-4 multicast message. However, according to various embodiments, if the configurations of the receivers 120 allocated to the carrier are taken into consideration, the transmitter 110 needs to transmit the same multicast message several times so that each of the four receivers 120 decodes each subfile. Accordingly, the transmitter 110 may generate a multicast message having a different order based on the configurations of the receivers 120 allocated to the carrier.

In i=1, an order-4 multicast user set to be transmitted may be configured. However, the order-4 multicast message cannot be generated because the number of receivers 120 allocated to the carrier is 3, as shown in FIG. 7. Accordingly, the transmitter 110 may skip to a multicast user set of i=2 and order-3. In the case of order-3, [A]₂={{1, 2, 4}, {1, 3, 5}, {2, 4, 5}, {3, 4, 5}} may be generated depending on carrier user allocation. In this case, in the case of A={1, 2, 4}, a parent set may be P_{A}={{1, 2, 3, 4}, {1, 2, 4, 5}}. In the case of P={1, 2, 3, 4}, all the remaining messages

$$( 1 , 1 , 0 , 1 , 0 ) \times F / ( \begin{matrix}5 \\ 3\end{matrix} )$$

corresponding to 1, 2, and 4 may be transmitted as A={1, 2, 4} because a child set includes only one A={1, 2, 4}. In the case of P={1, 2, 4, 5}, a message of a

$$( 1 , 0.5 , 0 , 0.5 , 0 ) \times F / ( \begin{matrix}5 \\ 3\end{matrix} )$$

size and a message of a

$$( 0 , 0.5 , 0 , 0.5 , 1 ) \times F / ( \begin{matrix}5 \\ 3\end{matrix} )$$

size may be distributed to {1, 2, 4} and {2, 4, 5}, respectively, because a child set includes {1, 2, 4} and {2, 4, 5} and the transmission rates of carriers are the same. That is, the message corresponding to overlapping 2 and 4 may be split by half and distributed. Accordingly, the size of the message \tilde{W}_{k,A\{k}} of each user of A={1, 2, 4} is

$$( {I}_{A , k} \text{:} k ∈ \{ 1 , … , 5 \} ) = ( 2 , 1.5 , 0 , 1.5 , 0 ) \times F / ( \begin{matrix}5 \\ 3\end{matrix} ) .$$

A multicast message \tilde{W}_{1,{2,4}} ⊕ \tilde{W}_{2,{1,4}} ⊕ \tilde{W}_{4,{1,2}} may be generated based on the size of

$${S}_{A} = {min}_{k ∈ A} {I}_{A , k} = 1.5 \times F / ( \begin{matrix}5 \\ 3\end{matrix} ) ,$$

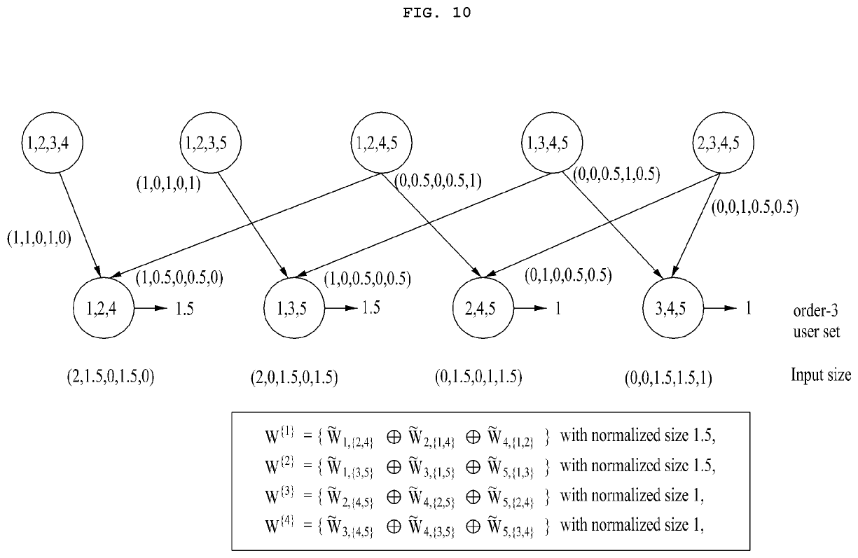

that is, the smallest value size of the sizes of the messages. \tilde{W}_{1,{2,4}} ⊕ \tilde{W}_{2,{1,4}} ⊕ \tilde{W}_{4,{1,2}} may be put into the multicast message set W^{{1}} for the carrier 1. Likewise, a multicast message may be generated with respect to A={1, 3, 5}, {2, 4, 5}, {3, 4, 5}, as shown in FIG. 10. The message set W^{L}, L^{⊂}{1,2,3,4} generated using such a method may be represented like Equation 12.

W^{{1}}={\tilde{W}_{1,{2,4}} ⊕\tilde{W}_{2,{1,4}} ⊕ \tilde{W}_{4,{1,2}} with size 1.5, \tilde{W}_{1,{2}} ⊕ \tilde{W}_{2,{1}} with size 0.5},

W^{{2}}={\tilde{W}_{1,{3,5}} ⊕ \tilde{W}_{3,{1,5}} ⊕ \tilde{W}_{5,{1,3}} with size 1.5, \tilde{W}_{1,{3}} ⊕ \tilde{W}_{3,{1}} with size 0.5},

W^{{3}}={\tilde{W}_{2,{4,5}} ⊕ \tilde{W}_{4,{2,5}} ⊕ \tilde{W}_{5,{2,4}} with size 1, \tilde{W}_{2,{5}} ⊕ \tilde{W}_{5,{2}} with size 0.5},

W^{{4}}={\tilde{W}_{3,{4,5}} ⊕ \tilde{W}_{4,{3,5}} ⊕ \tilde{W}_{5,{3,4}} with size 1, \tilde{W}_{3,{4}} ⊕ \tilde{W}_{4,{3}} with size 0.5},

W^{{1,3}}={\tilde{W}_{2,ϕ} with size 0.5},

W^{{2,4}}={\tilde{W}_{3,ϕ} with size 0.5}.

In this case, the sizes of the multicast message sets may be

$$\vert {W}^{\{ 1 \}} \vert = 2 F / ( \begin{matrix}5 \\ 3\end{matrix} ) = F / 5 , \vert {W}^{\{ 2 \}} \vert = F / 5 , \vert {W}^{\{ 3 \}} \vert = 3 F / 20 , \\ \vert {W}^{\{ 4 \}} \vert = 3 F / 20 , \vert {W}^{\{ 1 , 3 \}} \vert = F / 20 , \vert {W}^{\{ 2 , 4 \}} \vert = F / 20 .$$

When the user 1 receives the message of W^{{1}} and W^{{2}}, it may obtain \tilde{W}_{1,{2,4}}, \tilde{W}_{1,{3,5}}, \tilde{W}_{1,{2}}, \tilde{W}_{1,{3}}, (total size 4 subfiles) through information stored in the memory. Likewise, the remaining users may obtain the four subfiles.

At operation 530, the transmitter 110 may configure carrier messages (X^{l}, l∈{1, . . . , L}). The processor 440 may configure the carrier messages (X^{l}) for the respective carriers 130 by allocating the multicast message sets (W^{L}) to the carriers 130. In this case, the processor 440 may configure the carrier messages (X^{l}) by allocating the multicast messages of the multicast message set (W^{L}) to the carriers 130 based on the message size (|W^{L}|) of the multicast message set (W^{L}) and the transmission rate (R^{l}) of each carrier 130.

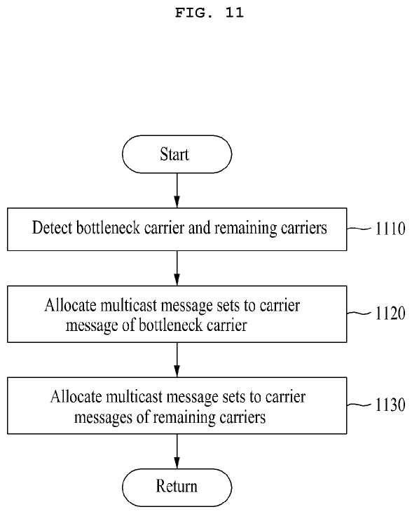

According to an embodiment, each of all the receivers 120 may be configured to store at least one of the files (Wᵢ, i∈{1, . . . , N}) of the transmitter 110 using a uniform caching method. In such a case, the transmitter 110 may configure the carrier messages (X^{l}, l∈{1, . . . , L}) according to an operation, such as that described with reference to FIG. 11.

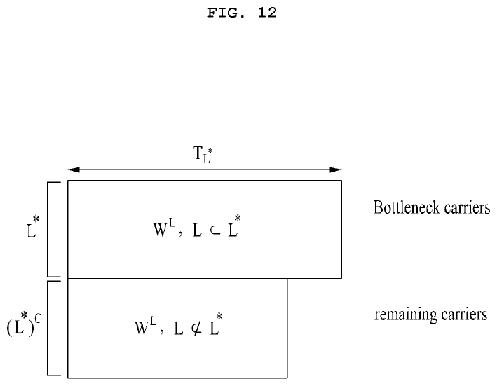

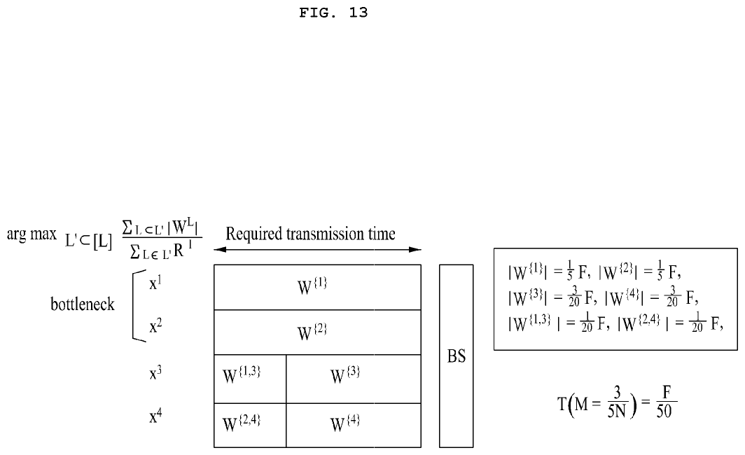

FIG. 11 is a diagram showing an operation of configuring a carrier message in FIG. 5. FIGS. 12 and 13 are diagrams illustrating an operation of configuring a carrier message in FIG. 5.

Referring to FIG. 11, at operation 1110, the transmitter 110 may detect carriers as at least one bottleneck carrier and the remaining carriers. The processor 440 may detect carriers 130 as a bottleneck carrier and the remaining carriers based on the transmission rate (R^{l}) of the carriers 130. In this case, the transmission time of the bottleneck carrier may be a maximum from among the transmission times of the carriers 130. The processor 440 may obtain next required transmission times of the carriers 130 based on the message size (|W^{L}|) of multicast message sets and the transmission rate (R^{l}) of the carriers 130 as represented in Equation 13, and may detect a bottleneck carrier (L*) having a maximum transmission time (T_{L}*) of the transmission times.

$${L}^{*} ← arg {max}_{{L}^{′} ⋐ \{ 1 , … , L \}} \frac{{\sum }_{L ⋐ {L}^{′}} \vert {W}^{L} \vert}{{\sum }_{1 ⋐ {L}^{′}} {R}^{1}} , \\ {T}_{L}^{*} ← \frac{{\sum }_{L ⋐ {L}^{′}} \vert {W}^{L} \vert}{{\sum }_{1 ⋐ {L}^{*}} {R}^{1}} \qquad [ Equation 13 ]$$

At operation 1120, the transmitter 110 may allocate multicast message sets to the carrier message of the bottleneck carrier. The processor 440 may allocate the multicast message sets to the carrier message of the bottleneck carrier based on the message size (|W^{L}|) of the multicast message sets, as shown in FIG. 12. In this case, the processor 440 may allocate some ({W^{L}: L^{⊂}L*}) of the multicast message sets to the carrier message ({X^{l}: l∈L*}) of the bottleneck carrier in accordance with the transmission time (T_{L}*) of the bottleneck carrier.

At operation 1130, the transmitter 110 may allocate multicast message sets to the carrier messages of the remaining carriers. The processor 440 may allocate the remaining set ({W^{L}: L/⊂ L*}) of the multicast message sets to the carrier messages of the remaining carriers (\tilde{L}=(L*)^{c}), as shown in FIG. 12. To this end, the transmitter may update the multicast message sets as in Equation 14. Accordingly, the processor 440 may allocate the multicast message set {W^{L}: L^{⊂}\tilde{L}} to the carrier messages {X^{l}: l∈\tilde{L}} of the carrier \tilde{L}=(L*)^{c}. Thereafter, the transmitter 110 may return to FIG. 5.

W^{L}←W^{L}∩(∩_{L′}^{⊂}L* W^{L}_{∩}^{L′}) [Equation 14]

For example, in the environment in which L=4, K=5, γ=MK/N=3, and R=(10,10,10,10), when the configurations of the receivers 120 allocated to each carrier are V^{l}={1, 2, 4}, V²={1, 3, 5}, V³={2, 4, 5}, V⁴={3, 4, 5}, bottleneck carriers may be 1 and 2. Accordingly, as shown in FIG. 13, W^{{1}} and W^{{2}} may be allocated the carriers 1 and 2, respectively. W^{{1,3}} may be allocated to the carriers 1 and 3, but the entire W^{{1,3}} may be allocated to the carrier 3 as shown in FIG. 13 because the carrier 1 is a bottleneck carrier. Likewise, W^{{2,4}} may be allocated to a carrier 4. In this case, a required transmission time may be

$$\frac{F}{5} \cdot \frac{1}{10} = \frac{F}{50} .$$

At operation 540, the transmitter 110 may transmit the carrier messages (X^{l}) through carriers 130. The processor 440 may transmit the carrier messages (X^{l}) based on the transmission rate (R^{l}) of each carrier 130. The carrier messages (X^{l}, l∈{1, . . . , L}) may be transmitted by each carrier (l) at the transmission rate (R^{l}).

According to another embodiment, all the receivers 120 may be configured to store at least one of the files (Wᵢ, i∈{1, . . . , N}) of the transmitter 110 using a random caching method. In such a case, the number of receivers 120 that store the same subfile may be various from 0 to K because each receiver 120 randomly selects and stores part of a file. A value γ in the uniform caching method according to an embodiment may be 0 to K. A multicast message set (W^{L}) in a random caching method may be configured by updating W^{L} with messages generated by repeating a multicast message set configuration algorithm in uniform caching up to γ=0˜K−1 (a subfile of γ=K does not need to be transmitted because it is a file owned by all users.). That is, W^{L} may be repeatedly updated by applying a multicast message set configuration algorithm in the uniform caching method according to an embodiment to all γ ∈{0, . . . , K} and the size

$$( \frac{{M}^{γ}}{N} \cdot {( 1 - \frac{M}{N} )}^{k - γ} \cdot F )$$

of a corresponding subfile. When the configuration of the multicast message set (W^{L}) is completed, carrier message configuration and transmission may be applied in the same manner as the uniform caching method according to an embodiment.

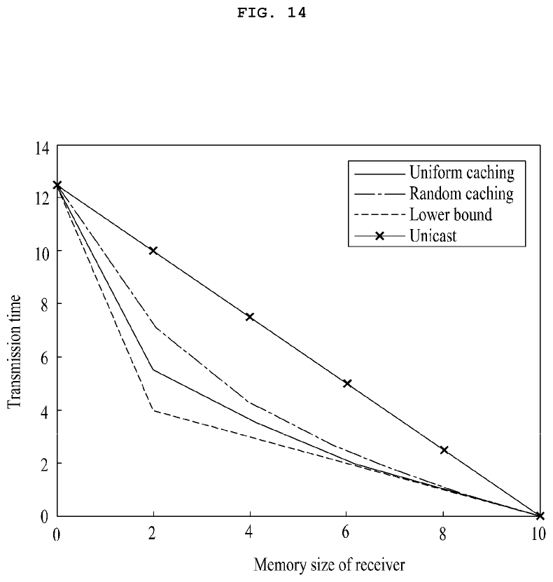

According to various embodiments, in a carrier aggregation environment, the transmitter 110 allocates several receivers 120 to one carrier 130 using memory information of the receivers 120 and provides services at the same time, thereby being capable of improving transmission efficiency. According to various embodiments, a total transmission time (T) taken for the transmitter 110 to satisfy the needs of the receivers 120 based on the configurations of the receivers 120 allocated to each carrier 130 and the transmission rate of each carrier 130 can be reduced. For example, in the environment in which L=4, K=5, N=10, F=100 bits, and R=(10,10,10,10), when the configurations of the receivers 120 allocated to each carrier are V¹={1, 2, 4}, V²={1, 3, 5}, V³={2, 4, 5}, V⁴={3, 4, 5}, transmission times taken for the uniform caching method according to an embodiment and the random caching method according to another embodiment may be shown as shown in FIG. 14.

The carrier aggregation system 100 according to various embodiments may include a plurality of receivers 120 and the transmitter 110 configured to transmit at least one file to the receivers 120 through a plurality of carriers 130.

According to various embodiments, the transmitter 110 may be configured to configure multicast message sets corresponding to the carriers 130, respectively, based on at least one file to be received by each of the receivers 120 allocated to a plurality of carriers 130, allocate the multicast message sets to the carriers 130, and transmit the multicast message sets through the carriers 130.

According to various embodiments, the transmitter 110 may be configured to generate multicast user sets indicative of the receivers 120 respectively allocated to the carriers 130, configure at least one parent set for each of the multicast user sets, determine a message size for each of the multicast user sets based on the parent set, and generate multicast message sets using the message size.

According to various embodiments, the transmitter 110 may be configured to detect carriers as at least one bottleneck carrier and the remaining carriers based on the transmission times of carriers 130, and may allocate multicast message sets to the bottleneck carrier and the remaining carriers based on the message size of the multicast message sets.

The transmitter 110 according to various embodiments may include the communication module 420 and the processor 440 connected to the communication module 420 and configured to transmit at least one file to a plurality of receivers 120 through a plurality of carriers 130 using the communication module 420.

According to various embodiments, the processor 440 may be configured to configure multicast message sets corresponding to a plurality of carriers 130, respectively, based on at least one file to be received by each of the receivers 120 allocated to the carriers 130, allocate the multicast message sets to the carriers 130, and transmit the multicast message sets through the carriers 130.

According to various embodiments, the processor 440 may be configured to generate multicast user sets indicative of receivers 120 respectively allocated to carriers 130, configure at least one parent set for each of the multicast user sets, determine a message size for each of the multicast user sets based on the parent set, and generate multicast message sets using the message size.

According to various embodiments, the parent set may include at least one of the multicast user sets.

According to various embodiments, the processor 440 may be configured to detect carriers 130 as at least one bottleneck carrier and the remaining carriers based on the transmission times of the carriers 130 and to allocate multicast message sets to the bottleneck carrier and the remaining carriers based on the message size of the multicast message sets.

According to various embodiments, the transmission time of the bottleneck carrier may be a maximum from among the transmission times of the carriers 130.

According to various embodiments, the processor 440 may be configured to allocate some of multicast message sets to a bottleneck carrier in accordance with the transmission time of the bottleneck carrier and to allocate the remaining sets of the multicast message sets to the remaining carriers.

An operating method of the transmitter 110 according to various embodiments may include an operation of configuring multicast message sets corresponding to a plurality of carriers 130, respectively, based on at least one file to be received by each of the receivers 120 allocated to the carriers 130 and an operation of allocating the multicast message sets to the carriers 130 and transmitting the multicast message sets through the carriers 130.

According to various embodiments, the configuring operation may include an operation of generating multicast user sets indicative of the receivers 120 respectively allocated to the carriers 130, an operation of configuring at least one parent set for each of the multicast user sets, an operation of determining a message size for each of the multicast user sets based on the parent set, and an operation of generating multicast message sets using the message size.

According to various embodiments, the parent set may include at least one of the multicast user sets.

According to various embodiments, the transmitting operation may include an operation of detecting carriers 130 as at least one bottleneck carrier and the remaining carriers based on the transmission times of the carriers 130 and an operation of allocating the multicast message sets to the bottleneck carrier and the remaining carriers based on the message size of the multicast message sets.

According to various embodiments, the transmission time of the bottleneck carrier may be a maximum from among the transmission times of the carriers 130.

According to various embodiments, the allocating operation may include an operation of allocating some of the multicast message sets to the bottleneck carrier in accordance with the transmission time of the bottleneck carrier and an operation of allocating the remaining sets of the multicast message sets to the remaining carriers.

The embodiments of this document and the terms used in the embodiments are not intended to limit the technology described in this document to a specific embodiment, but should be construed as including various changes, equivalents and/or alternatives of a corresponding embodiment. Regarding the description of the drawings, similar reference numerals may be used in similar elements. An expression of the singular number may include an expression of the plural number unless clearly defined otherwise in the context. In this document, an expression, such as “A or B”, “at least one of A or/and B”, “A, B or C” or “at least one of A, B and/or C”, may include all of possible combinations of listed items together. Expressions, such as “a first,” “a second,” “the first” and “the second”, may modify corresponding elements regardless of the sequence and/or importance, and are used to only distinguish one element from the other element and do not limit corresponding elements. When it is described that one (e.g., first) element is “(operatively or communicatively) connected to” or “coupled with” the other (e.g., second) element, one element may be directly connected to the other element or may be connected to the other element through another element (e.g., third element).

The “module” used in this document may include a unit configured with hardware, software or firmware and may be interchangeably used with a term, such as logic, a logical block, a part or a circuit. The module may be an integrated part, a minimum unit to perform one or more functions, or a part thereof. For example, the module may be configured with an application-specific integrated circuit (ASIC).

Various embodiments of this document may be implemented as software including one or more instructions stored in a storage medium (e.g., memory 330) readable by a machine (e.g., transmitter 110). For example, the processor (e.g., processor 340) of the machine may fetch at least one of the stored one or more instructions from the storage medium, and may execute the instruction. This enables the machine to operate to perform at least one function in response to the fetched at least one instruction. The one or more instructions may include code generated by a compiler or code which may be executed by an interpreter. The machine-readable storage medium may be provided in the form of a non-transitory storage medium. In this case, the term “non-transitory” means that the storage medium is a tangible device and a signal (e.g., electromagnetic) is not included. The term does not distinguish between a case where data is semi-permanently stored in the storage medium and a case where data is temporally stored in the storage medium.

According to various embodiments, each (e.g., module or program) of the described elements may include a single entity or a plurality of entities. According to various embodiments, one or more of the above-described elements or operations may be omitted or one or more other elements or operations may be added. Alternatively, or additionally, a plurality of elements (e.g., modules or programs) may be integrated into one element. In such a case, the integrated elements may perform one or more functions of each of a plurality of elements identically with or similar to that performed by a corresponding one of the plurality of elements before the elements are integrated. According to various embodiments, module, operations performed by a program or other elements may be executed sequentially, in parallel, repeatedly, or heuristically, or one or more of the operations may be executed in different order or may be omitted, or one or more other operations may be added.

According to various embodiments, in a carrier aggregation environment, transmission efficiency can be improved because the transmitter allocates several receivers to one carrier using memory information of the receivers and provides services at the same time.

According to various embodiments, a total transmission time (T) necessary for the transmitter to satisfy the needs of receivers based on the configurations of the receivers allocated to each carrier and the transmission rate of each carrier can be reduced.

What is claimed is:

1. An operating method of a transmitter transmitting at least one file to a plurality of receivers through a plurality of carriers, the method comprising:
configuring multicast message sets corresponding to a plurality of carriers, respectively, based on at least one file to be received by each of receivers allocated to the carriers, respectively; and
allocating the multicast message sets to the carriers and transmitting the multicast message sets through the carriers.

2. The method of claim 1, wherein the configuring operation comprises:
generating multicast user sets indicative of the receivers allocated to the carriers;
configuring at least one parent set for each of the multicast user sets;
determining a message size for each of the multicast user sets based on the parent set; and
generating the multicast message sets using the message size.

3. The method of claim 2, wherein the parent set comprises at least any one of the multicast user sets.

4. The method of claim 2, wherein the transmitting operation comprises:
detecting the carriers as at least one bottleneck carrier and remaining carriers based on transmission times of the carriers; and
allocating the multicast message sets to the bottleneck carrier and the remaining carriers based on the message size of the multicast message sets.

5. The method of claim 4, wherein a transmission time of the bottleneck carrier is a maximum from among the transmission times of the carriers.

6. The method of claim 5, wherein the allocating operation comprises:
allocating some of the multicast message sets to the bottleneck carrier in accordance with the transmission time of the bottleneck carrier; and
allocating remaining sets of the multicast message sets to the remaining carrier.

7. A transmitter, comprising:
a communication module; and
a processor connected to the communication module and configured to transmit at least one file to a plurality of receivers through a plurality of carriers using the communication module,
wherein the processor is configured to:
configure multicast message sets corresponding to a plurality of carriers, respectively, based on at least one file to be received by each of receivers allocated to the carriers, respectively; and
allocate the multicast message sets to the carriers and transmit the multicast message sets through the carriers.

8. The transmitter of claim 7, wherein the processor is configured to:
generate multicast user sets indicative of the receivers allocated to the carriers;
configure at least one parent set for each of the multicast user sets;
determine a message size for each of the multicast user sets based on the parent set; and
generate the multicast message sets using the message size.

9. The transmitter of claim 8, wherein the parent set comprises at least any one of the multicast user sets.

10. The transmitter of claim 8, wherein the processor is configured to:
detect the carriers as at least one bottleneck carrier and remaining carriers based on transmission times of the carriers; and
allocate the multicast message sets to the bottleneck carrier and the remaining carriers based on the message size of the multicast message sets.

11. The transmitter of claim 10, wherein a transmission time of the bottleneck carrier is a maximum from among the transmission times of the carriers.

12. The transmitter of claim 11, wherein the processor is configured to:
allocate some of the multicast message sets to the bottleneck carrier in accordance with the transmission time of the bottleneck carrier; and
allocate remaining sets of the multicast message sets to the remaining carrier.

13. A carrier aggregation system, comprising:
a plurality of receivers; and
a transmitter configured to transmit at least one file to the receivers through a plurality of carriers,
wherein the transmitter is configured to:
configure multicast message sets corresponding to a plurality of carriers, respectively, based on at least one file to be received by each of receivers allocated to the carriers, respectively; and
allocate the multicast message sets to the carriers and transmit the multicast message sets through the carriers.

14. The system of claim 13, wherein the transmitter is configured to:
generate multicast user sets indicative of the receivers allocated to the carriers;
configure at least one parent set for each of the multicast user sets;
determine a message size for each of the multicast user sets based on the parent set; and
generate the multicast message sets using the message size.

15. The system of claim 14, wherein the transmitter is configured to:
detect the carriers as at least one bottleneck carrier and remaining carriers based on transmission times of the carriers; and
allocate the multicast message sets to the bottleneck carrier and the remaining carriers based on the message size of the multicast message sets.
